(19) United States
(12) Patent Application Publication
(10) Pub. No.: US 2012/0065345 A1
(43) Pub. Date: Mar. 15, 2012

(54) SUPPORTED HYBRID CHROMIUM-BASED CATALYSTS, PROCESSES FOR PREPARING THE SAME, AND USES THEREOF

(76) Inventors: Yan TANG, Shandong Province (CN); Boping Liu, Shandong Province (CN); Jianwen Da, Shandong Province (CN); Shiliang Zhang, Shandong Province (CN); Kan Xie, Shandong Province (CN); Qi Dong, Shandong Province (CN)

(21) Appl. No.: 13/208,616

(22) Filed: Aug. 12, 2011

(30) Foreign Application Priority Data
Aug. 12, 2010 (CN) 201010251149.9

(51) Int. Cl. C08F 4/78; C08F 210/16; C07F 11/00; C08F 110/02

(52) U.S. Cl. 526/118; 502/62; 502/171; 556/57; 556/10

(57) ABSTRACT

Disclosed are a supported hybrid chromium-based catalyst comprising a porous inorganic support, at least one inorganic oxide Cr active site (A), and at least one organic Cr active site (B), wherein the at least one inorganic oxide Cr active site (A) and the at least one organic Cr active site (B) are both supported on the porous inorganic support, processes for producing the supported hybrid chromium-based catalyst and processes for producing ethylene homopolymers and/or ethylene copolymers using the catalysts of the present disclosure.

This application claims priority under 35 U.S.C. §119 to Chinese Patent Application No. 201010251149.9, filed Aug. 12, 2010.

The present disclosure relates to polyolefin catalysts, and specifically relates to a supported hybrid chromium-based catalyst, which can be used for synthesizing a polyolefin resin having a broad molecular weight distribution.

Polyethylene (PE) resin is a thermoplastic plastic polymerized from ethylene monomer, and is one of the most largely produced and consumed general plastic products in the world. The types of PE include low density polyethylene (LDPE), linear low density polyethylene (LLDPE), high density polyethylene (HDPE), as well as some other polyethylenes having special properties. PE has excellent mechanical behavior, electrical insulation properties, chemical resistance, low temperature resistance, and processability, and PE products are widely used in industry, agriculture, automobiles, communications, and various fields in daily life.

Catalysts that have been used to produce PE include, for example, Ziegler-Natta (Z-N) type catalysts, chromium catalysts, metallocene catalysts, and some other non-metallocene catalysts. Chromium catalysts are popular in the market due to its prominent contribution to HDPE production and the non-substitutability of the product thereof. Even today, 40% of HDPE is still produced from chromium catalysts.

U.S. Pat. No. 2,825,721 discloses a silica gel-supported chromic oxide catalyst, i.e., the best known Phillips catalyst. On the basis of U.S. Pat. No. 2,825,721, some patents, including U.S. Pat. Nos. 2,951,816, 2,959,577 and 4,194,073, disclose the modifications and studies on such supported chromic oxide catalyst. In addition, some U.S. patents, e.g. U.S. Pat. Nos. 4,294,724, 4,295,997, 4,528,338, 5,401,820, and 6,388,017, also relate to the Phillips catalyst.

U.S. Pat. Nos. 3,324,101 and 3,324,095, and Canadian Patent No. 759121 disclose an organic chromium catalyst, i.e. S-2 catalyst produced by Union Carbide Company. Belgium Patent No. 802601 discloses a chromium catalyst using cyclopentadiene as the ligand.

Although there are various polyolefin catalysts, there are still needs to further improve the properties of the catalysts.

Disclosed herein are a supported hybrid chromium-based catalyst (“hybrid Cr catalyst”) prepared by using at least two different chromium precursors, i.e., inorganic chromium precursor and organic chromium precursor, a process for preparing the same and use thereof. The hybrid chromium-based catalyst disclosed herein can be easy to prepare, and of low cost. In addition, the hybrid Cr catalyst disclosed herein can produce polyethylene resins having the properties of a broad molecular weight distribution, good hydrogen response, and excellent α-olefin copolymerization characteristics.

Specifically, disclosed herein is a supported hybrid chromium-based catalyst comprising at least one inorganic oxide Cr active site (A), at least one organic Cr active site (B), and at least one porous inorganic support, wherein the at least one inorganic oxide Cr active site (A) and the at least one organic Cr active site (B) are both present (i.e., supported) on one porous inorganic support.

In some embodiments of the present disclosure, the at least one inorganic oxide Cr active site (A) is chosen from forms (a), (b), and (c) below, and is supported on the at least one inorganic support:

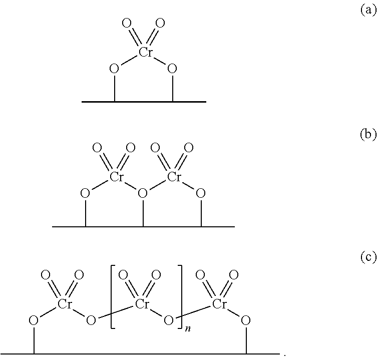

The inorganic oxide Cr active sites mentioned above are disclosed in, for example, Journal of Molecular Catalysis A: Chemical 172 (2001), pp. 227-240.

In some embodiments of the present disclosure, the at least one inorganic oxide Cr active site (A) is derived from at least one inorganic chromium precursor chosen from chromium trioxide, chromic nitrate, chromic acetate, chromic chloride, chromic sulfate, ammonium chromate, ammonium dichromate, chromium acetate hydroxide, and other suitable soluble salts of chromium, for example, chromic acetate and chromium acetate hydroxide.

In some embodiments of the present disclosure, the chemical structure of the at least one organic Cr active site (B) is in a form of

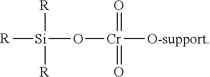

The at least one organic Cr active site (B) mentioned above is disclosed in, for example, U.S. Pat. No. 3,324,095 and Kevin Cann et al., Macromol. Symp. 2004, 213, pp. 29-36.

In one embodiment of the present disclosure, the organic chromium precursor for the at least one organic Cr active site (B) above is a compound having the formula

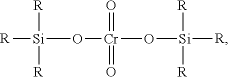

wherein R, which is identical or different from each other, is chosen from hydrocarbyl radicals comprising from 1 to 14 carbon atoms, such as from 3 to 10 carbon atoms.

In another embodiment of the present disclosure, R is chosen from alkyl radicals and aryl radicals comprising from 1 to 14 carbon atoms, such as from 3 to 10 carbon atoms, and for example, chosen from methyl, ethyl, propyl, iso-propyl, n-butyl, iso-butyl, t-butyl, n-pentyl, iso-pentyl, t-pentyl, hexyl, 2-methyl-pentyl, heptyl, octyl, 2-ethylhexyl, nonyl, decyl, hendecyl, dodecyl, tridecyl, tetradecyl, benzyl, phenethyl, p-methylbenzyl, phenyl, tolyl, xylyl, naphthyl, ethylphenyl, methylnaphthyl, and dimethylnaphthyl radicals.

In yet another embodiment of the present disclosure, the at least one organic chromium precursor is chosen from bis-trimethylsilylchromate, bis-triethylsilylchromate, bis-tributylsilylchromate, bis-triisopentylsilylchromate, bis-tri-2-ethylhexylsilylchromate, bis-tridecylsilylchromate, bis-tri(tetradecyl)-silylchromate, bis-tribenzylsilylchromate, bis-triphenethylsilylchromate, bis-triphenylsilylchromate, bis-tritolylsilylchromate, bis-trixylylsilylchromate, bis-trinaphthylsilylchromate, bis-triethylphenylsilylchromate, bis-trimethyl-naphthylsilylchromate, polydiphenylsilylchromate, and polydiethylsilylchromate. In one embodiment, the at least one organic chromium precursor is bis-triphenylsilylchromate.

In some embodiments of the present disclosure, the total amount of chromium loaded on the at least one inorganic support ranges from 0.01% to 5%, such as from 0.05% to 4%, further such as from 0.1% to 2%, by weight relative to the total weight of the catalyst.

In some embodiments of the present disclosure, the chromium in the at least one inorganic oxide Cr active site (A) is present in an amount ranging from 10% to 90%, such as from 20% to 80%, further such as from 30% to 70%, even further such as from 40% to 60%, and for example, about 50%, by weight relative to the total weight of the chromium loaded on the at least one inorganic support, and the at least one organic Cr active site (B) comprises the remaining amount of the chromium loaded on the at least one inorganic support.

The at least one inorganic support used in the present disclosure may be any inorganic support generally used for preparing a catalyst for olefin polymerization. In one embodiment of the present disclosure, the inorganic support is chosen from silica, alumina, titania, zirconia, magnesia, calcium oxide, inorganic clays, and combinations thereof. The inorganic clays may include, e.g. montmorillonite and the like. In one embodiment of the present disclosure, the at least one inorganic support is chosen from unmodified, Ti-, Al-, and F-modified silica gel, such as amorphous porous silica gel. These supports are commercially available or can be synthesized by the known processes. As an example of the silica gel, DAVISON 955 may be used.

In one embodiment of the present disclosure, the at least one inorganic support has a pore volume ranging from 0.5 cm³/g to 5.0 cm³/g, such as from 1.0 cm³/g to 3.0 cm³/g, further such as from 1.3 cm³/g to 2.5 cm³/g, and even further such as from 1.5 cm³/g to 1.8 cm³/g. In one embodiment, the at least one inorganic support has a surface area ranging from 100 m²/g to 600 m²/g, such as from 150 m²/g to 500 m²/g, further such as from 220 m²/g to 400 m²/g, and even further such as from 250 m²/g to 350 m²/g. The pore volume and surface area may be determined by the BET method known by those skilled in the art.

The at least one inorganic support can, for example, have an average particle size ranging from 1 μm to 100 μm, such as from 5 μm to 80 μm, and further such as from 10 μm to 60 μm. The average particle size is determined by conventional measuring methods known in the art, for example, a laser particle size measuring method. For example, the average particle size can be measured as follows: measuring the average particle size as well as particle size distribution of a sample by using the LS 230 Laser Diffraction Particle Size Analyzer from Beckman Coulter Inc., for example after the wet dispersion of the sample.

Further disclosed herein is a process for preparing a supported hybrid chromium-based catalyst, comprising:

i) impregnating at least one inorganic support into at least one aqueous solution comprising at least one inorganic chromium precursor, drying, and calcining the at least one inorganic support at a temperature ranging from 500° C. to 900° C.; and

ii) impregnating the at least one inorganic support obtained in step i) into at least one solution comprising at least one organic chromium precursor, and then drying.

In some embodiments, the process for preparing a supported hybrid chromium-based catalyst of the present disclosure comprises:

i) impregnating at least one inorganic support into at least one aqueous solution comprising at least one inorganic chromium precursor, retaining at a temperature ranging from room temperature to 80° C. for a period of time ranging from 1 h to 12 h, drying at a temperature ranging from 100° C. to 200° C. for a period of time ranging from 1 h to 18 h, and calcining in air at a temperature ranging from 500° C. to 900° C. for a period of time ranging from 1 h to 10 h, and cooling, wherein air is replaced with nitrogen gas when it is cooled to a temperature ranging from 300° C. to 400° C.;

ii) impregnating the at least one inorganic support obtained in step i) into at least one organic chromium precursor solution under nitrogen atmosphere, reacting at a temperature ranging from room temperature to 80° C. for a period of time ranging from 1 h to 10 h, and then drying at a temperature ranging from 60° C. to 120° C. for a period of time ranging from 2 h to 8 h.

In some embodiments, the process for preparing a supported hybrid chromium-based catalyst comprises:

(i) using at least one inorganic support as the support, first impregnating the at least one inorganic support with a first chromium precursor (an inorganic chromium precursor) thereon, calcining at high temperature to obtain a conventional Phillips catalyst; and

(ii) adding a second chromium precursor (an organic chromium precursor) into a solution containing the above obtained inorganic support so as to prepare a chromium hybrid catalyst.

Generally, the step i) is similar to the preparation of the conventional Phillips catalyst, while the step ii) is similar to the preparation of the conventional S-2 catalyst.

Said step i) relates to a method of depositing an inorganic chromium precursor onto the inorganic support (for example the inorganic support mentioned above), and such an method may be any method, known by those skilled in the art, capable of depositing chromium onto a support, e.g. the conventional and known method for preparing a Phillips catalyst. The inorganic chromium precursor may be the inorganic chromium precursor as described above.

In one embodiment of the present disclosure, the method of depositing at least one inorganic chromium precursor onto the at least one inorganic support comprises impregnating at least one porous inorganic support with at least one aqueous solution comprising at least one inorganic chromium precursor. In one embodiment, stirring, such as continuous stirring, can be implemented during the impregnation. Generally, such stirring lasts for a period of time ranging from about 1 h to about 24 h, such as from about 2 h to about 12 h, and further such as from about 3 h to about 8 h.

In one embodiment, the amount of inorganic chromium loading is at most 5.00% by weight relative to the total weight of the catalyst, such as ranging from about 0.01% to about 4.00%, further such as from about 0.02% to about 3.00%, and even further such as from about 0.03% to about 2.00%, for example, from about 0.10% to about 1.00%, by weight relative to the total weight of the catalyst. Then the resultant inorganic chromium-support is dried, for example, at a temperature ranging from about room temperature to about 200° C., such as from about 15° C. to about 200° C., further such as from about 20° C. to about 200° C., and even further such as from about 100° C. to about 200° C. In one embodiment, the drying is conducted at about 150° C. In another embodiment, the drying is conducted under an inert atmosphere, for example, atmosphere of nitrogen gas, helium gas, and/or argon gas, such as nitrogen atmosphere, e.g. highly pure nitrogen. The duration period for such drying is not specially limited, but such drying may last for a period of time ranging from about 1 h to about 18 h, such as from about 1.5 h to about 12 h, further such as from about 2 h to 8 h, for example, about 200 min.

After drying, the chromium-supporting inorganic support is calcined. The calcining manner is not specifically limited, but it may be conducted within a fluidized bed. In one embodiment, such calcining is carried out by two stages, i.e., low temperature stage and high temperature stage. The low temperature stage may be conducted at a temperature ranging from about 200° C. to about 400° C., and the high temperature stage may be conducted at a temperature ranging from about 500° C. to about 900° C. Without any theoretical limitation, it is believed that the mechanical water of the support is removed during the low temperature stage, and the hydroxyl radical on the inorganic support is removed during the high temperature stage.

In one embodiment, the low temperature stage lasts for a period of time ranging from 1 h to 6 h, such as from 2 h to 5 h. In another embodiment, the high temperature stage lasts for a period of time ranging from 1 h to 10 h, such as from 2 h to 9 h, further such as from 3 h to 8 h, and even further such as from 5 h to 8 h. In one embodiment, the low temperature stage is carried out under an inert atmosphere, wherein the inert gas is chosen from, for example, nitrogen gas, helium gas, argon gas and the like.

In one embodiment, the calcining is carried out in air. After calcining, the resultant inorganic support supporting inorganic oxide Cr is cooled from the high temperature stage. In one embodiment, when the temperature is decreased to a temperature ranging from 300° C. to 400° C., the atmosphere can be changed, e.g. from air to an inert gas, such as nitrogen gas. In one embodiment, such cooling is a natural falling of temperature. Those skilled in the art will understand that the catalyst prepared accordingly is also called the Phillips catalyst.

Said step (ii) is a method for depositing an organic chromium precursor onto the inorganic support. Such a method is known by those skilled in the art, and said organic chromium precursor may be the organic chromium precursors as described above. Generally, the deposition of the organic chromium precursor is carried out after the deposition of the inorganic chromium precursor.

In one embodiment, at least one inorganic support (e.g. the inorganic support prepared in step (i)) supporting Cr in an inorganic oxide form is placed in a solvent, and at least one organic chromium precursor is added for depositing the organic chromium precursor onto the at least one inorganic support. The solvent can be any solvent capable of depositing the at least one organic chromium precursor onto the inorganic support, for example, the solvent conventionally used in the preparation of S-2 catalysts. For example, the solvent can be chosen from alkanes, such as n-pentane, n-hexane, n-heptane, and n-octane. In one embodiment, the solvent is n-hexane or h-heptane. In one embodiment, the solvent is a solvent treated by dehydration and deoxidation.

In one embodiment, the deposition of the at least one organic chromium precursor is generally carried out under stirring, such as continuous stirring. The stirring time is not specially limited as long as the reaction is completely conducted. In one embodiment, the stirring lasts for a period of time ranging from 1 h to 24 h, such as from 2 h to 16 h, and further such as from 3 h to 8 h.

In one embodiment, the deposition of the at least one organic chromium precursor is carried out under an inert gas atmosphere, such as nitrogen atmosphere. In one embodiment, the deposition of the at least one organic chromium precursor is carried out at a temperature ranging from room temperature to 100° C., such as from room temperature to 80° C.

In one embodiment, the organic chromium loading is at most 5.00% by weight relative to the total weight of the catalyst, such as from about 0.01% to about 4.00%, further such as from about 0.02% to about 3.00%, even further such as from about 0.03% to about 2.00%, for example, from about 0.1% to about 1.00%, by weight relative to the total weight of the catalyst.

After the completion of the deposition of the organic chromium precursor, the resultant hybrid catalyst is dried to remove the solvent so as to obtain the hybrid catalyst of the present disclosure. The drying may be conducted at a temperature ranging from 30° C. to 150° C., such as from 60° C. to 120° C. The drying may last for a period of time ranging from 1 h to 10 h, such as from 2 h to 8 h. In one embodiment, the drying is conducted under an inert gas atmosphere, e.g. atmosphere of nitrogen, helium, and/or argon gas, such as under nitrogen gas atmosphere. The resultant hybrid catalyst is stored under an inert gas atmosphere.

As a non-limiting example, the catalyst of the present disclosure is prepared as follows.

A porous amorphous silica gel is impregnated in an aqueous solution comprising chromium triacetate (CA) or chromium(III) acetate hydroxide (CAH) at a concentration that enables the chromium loading to be present in an amount ranging, for example, from 0.1% to 1% by weight relative to the total weight of the catalyst. After being continuously stirred for a period of time (e.g. from 3 h to 8 h), heated at and dried, the silica gel support supporting the CA or CAH is calcined at a low temperature stage and at a high temperature stage in a fluidized bed, wherein at the low temperature stage, the mechanical water of the support is removed; and at the high temperature stage (e.g. from 500° C. to 900° C.), hydroxyl radical on the surface of the silica gel is removed. The high temperature stage lasts for a period of time (e.g. from 5 h to 8 h). Finally, the silica gel was naturally cooled down under the protection of nitrogen gas to obtain a conventional Phillips catalyst. Such catalyst is then treated with a solvent (e.g. a refined hexane or heptane treated by dehydration and deoxidation) comprising a second chromium precursor, e.g. bis-triphenylsilylchromate, the mixture is then continuously stirred for a certain period of time (e.g. from 3 h to 8 h) in a bottle till complete reaction. The chromium loading from the second chromium precursor ranges, for example, from 0.1% to 1.0% by weight relative to the total weight of the catalyst. Finally the resultant hybrid catalyst is dried to remove the solvent and stored under the protection of nitrogen gas.

In some embodiments, the catalyst of the present disclosure is a catalyst in which the at least one inorganic oxide Cr active site (A) and the at least one organic Cr active site (B) are both present on the same one inorganic support at the same time. Such catalyst is different from the catalyst obtained by physically mixing the catalyst having inorganic oxide Cr active site (A) (e.g. the Phillips catalyst) and the catalysts having organic Cr active site (B) (e.g. S-2 catalyst), wherein in the physically mixed catalyst, the inorganic oxide Cr active site (A) and the organic Cr active site (B) are respectively present on distinct or different inorganic support particles.

As a non-limiting example, the at least one inorganic oxide Cr active site (A) (for example, the form (a)) and the at least one organic Cr active site (B) (for example, comprising triphenylsilyl radical) that are both supported on silica can be schematically illustrated as follows:

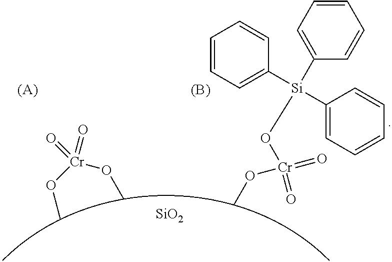

In contrast, the catalyst obtained by physically mixing the catalyst having an inorganic oxide Cr active site (A) and the catalyst having an organic Cr active site (B) can be schematically illustrated as follows:

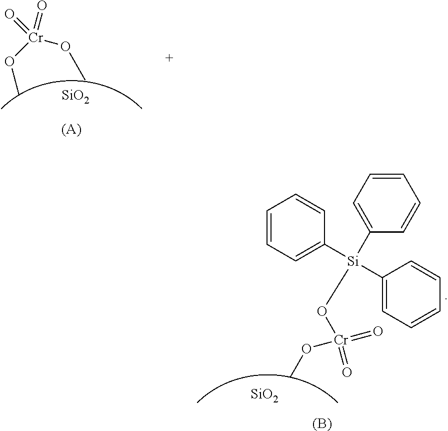

The supported hybrid chromium-based catalyst of the present disclosure can be used for producing olefin polymers.

Further disclosed herein is a process for producing an olefin polymer such as an olefin polymer having a broad molecular weight distribution by using the supported hybrid chromium-based catalyst of the present disclosure. Said process comprises contacting at least one olefin with an effective catalytic amount of at least one catalyst under the polymerization conditions, wherein the catalyst (also referred to as the compounded catalyst) comprises the supported hybrid chromium-based catalyst of the present disclosure and at least one co-catalyst component.

In some embodiments, the at least one olefin used for polymerization may comprise ethylene as the polymerization monomer. In one embodiment, the at least one olefin used for polymerization further comprises at least one comonomer. The comonomer may be chosen from α-olefins comprising from 3 to 20 carbon atoms, e.g. propylene, 1-butene, 1-pentene, 1-hexene, 1-heptene, 1-octene, 1-nonene, 1-decene, 1-dodecylene, 4-methyl-1-pentene, 4-methyl-1-hexene, and the like, which can be used alone or in combinations of two or more. For example, the comonomer may be chosen from 1-hexene, 1-octene, and 1-decene. The amount of the comonomer may range from 0% to 10% by volume relative to the total volume of the solvent used during the polymerization.

In some embodiments, the at least one co-catalyst comprises at least one aluminum compound. In one embodiment, the at least one aluminum compound is chosen from trialkylaluminum AIRS, dialkylalkoxyaluminum AlR2OR, dialkyl aluminum halide AlR2X, and aluminoxanes, wherein R is chosen from alkyl radicals comprising from 1 to 12 carbon atoms, such as methyl, ethyl, n-propyl, iso-propyl, n-butyl, iso-butyl, n-amyl, n-hexyl, n-heptyl, n-octyl, n-nonyl, and n-dodecyl radicals; X is halogen, such as fluorine, chlorine, bromine, and iodine, for example chlorine. Said aluminoxane may comprise methylaluminoxane (MAO). Said aluminum compounds as the co-catalyst can be used alone, or in combinations of two or more. As a non-limiting example, triethylaluminum, triisobutylaluminum, and methylaluminoxane can be used as the aluminum compounds.

In some embodiments, the at least one aluminum compound is used in an amount of, based on the moles of aluminum, from 1 mol/mol to 1,000 mol/mol, such as from 2 mol/mol to 70 mol/mol, further such as from 3 mol/mol to 50 mol/mol, relative to each mole of Cr.

In some embodiments, the polymerization process may use a molecular weight regulator, such as hydrogen.

In the process for preparing polymers as disclosed herein, there is no special limitation to the polymerization process. In some embodiments, the processes for preparing olefin polymers using the hybrid catalyst of the present disclosure can include gas phase polymerization, slurry polymerization, suspension polymerization, bulk polymerization, and/or solution polymerization. As understood by those skilled in the art, there is no special limitation to the process for preparing olefin polymers by using the hybrid catalyst of the present disclosure, and the process can be carried out by using the conventional implementation solutions and polymerization conditions of gas phase polymerization, slurry polymerization, suspension polymerization, bulk polymerization, and/or solution polymerization known in the art.

In some embodiments, the slurry polymerization is used, comprising adding ethylene to a reaction kettle, and then adding a solvent and a co-catalyst (an aluminum compound), optionally adding hydrogen and comonomer(s), and finally adding the hybrid catalyst of the present disclosure to start the polymerization.

As a non-limiting example, in one embodiment, the polymerization is carried out by the conventional slurry polymerization as follows.

A polymerization reaction kettle is first heated (100° C.) under vacuum, and then replaced with highly pure nitrogen, which is repeated for three times. A small amount of ethylene monomer is further used to replace once. Finally, the reaction kettle is filled with ethylene monomer to a slightly positive pressure (0.12 MPa). A refined solvent treated by dehydration and deoxidation and a certain amount of alkylaluminium as the co-catalyst are then added to the reaction kettle. If needed, as generally required in the hydrogen regulation and copolymerization experiments, a certain amount of hydrogen and comonomer(s) are added. Finally, the catalyst of present disclosure is added to start the polymerization. During the reaction, the instantaneous consumption rates of ethylene monomer are measured on-line by a high-precision ethylene mass flow meter connected to a computer and also recorded by the computer. After the reaction is conducted at a certain temperature (e.g. from 35° C. to 90° C.) for a certain period of time (e.g. 1 h), a mixed solution of hydrochloric acid/ethanol is added to terminate the reaction, and the polymer is washed, vacuum dried, weighed, and analyzed.

Further disclosed herein is a hybrid chromium-based catalyst prepared from depositing at least two different chromium precursors, for example, an inorganic chromium precursor such as chromium(III) acetate (CA) or chromium(III) acetate hydroxide(CAH), and an organic chromium precursor such as bis(triphenylsilyl)chromate (BC), onto the same one catalyst support.

The catalyst of the present disclosure can produce ethylene homopolymers and ethylene-α-olefin copolymers having a broad molecular weight distribution (MWD=20-40) in a single reactor. Using the hybrid catalyst of the present disclosure, by changing factors such as the amount of co-catalyst, polymerization temperature, and molecular weight regulator, the molecular weight and molecular weight distribution of ethylene homopolymers and ethylene-α-olefin copolymers can be conveniently and readily regulated, so as to conveniently and readily obtain polymers having the required properties.

### BRIEF DESCRIPTIONS OF THE DRAWINGS

FIG. 1 shows the DSC curves of the ethylene homopolymerization products under the action of different co-catalysts (example 4 (Al/Cr molar ratio=15:1), examples 5 and 6).

FIG. 2 shows the GPC curves of the ethylene homopolymerization products under the action of different co-catalysts (example 4 (Al/Cr molar ratio=15:1), examples 5 and 6).

FIG. 3 shows the temperature profile of the high-temperature calcining step followed by the cooling step for the preparation of the Phillips catalyst in the examples.

FIG. 4 shows the process of treating the silica gel support at 600° C. in Comparative Example 1.

FIG. 5 shows the kinetics curves of the catalyst of present disclosure with different co-catalysts at ethylene pressure of 0.14 MPa.

FIG. 6 shows the IR spectrogram of the hybrid catalysts of the present disclosure (examples 1-3), Phillips catalyst, and S-2 catalyst.

### EXAMPLES

The present disclosure is further illustrated by the following examples, but is not limited by these examples.

Various properties and physical performances in the examples are determined by the following methods.

The silica gel used in the examples is DAVISON 955 (surface area 250 m²/g, pore volume 1.5 cm³/g). The pore volume and surface area of this amorphous silica gel were determined by the conventional BET method.

### Melting Point

The melting point was determined by the DSC method. The specific process is as follows: about 6 mg of sample was weighted and heated to 150° C. at a rate of 10° C./min, kept for 5 minutes to remove thermal history, cooled down to 40° C. at a rate of 10° C./min, and finally heated to 150° C. at 10° C./min by a DSC analyzer (TA DSCQ200) to record the second heating curve and melt point (Tm) of the sample.

### Weight Average Molecular Weight and Molecular Weight Distribution

The weight average molecular weight (MW) and molecular weight distribution (MWD) of polymers were measured by high temperature gel permeation chromatography (HT-GPC, PL-220) with a polystyrene gel column (PL-Mixed B) at 140° C. and a flow rate of 1.0 ml/min, using 1,2,4-trichlorobenzene as a solvent. The data obtained was processed by the universal method of correction based on the narrow-distributed polystyrene standard samples.

### IR Spectroscopy

About 10 mg of chromium catalyst after washing with n-hexane was first mixed with KBr (Sample: KBr=1:100 (by weight)) and scanned by a FTIR spectrometer (Thermo Fisher, Nicolet 5700) with 2 cm⁻¹ resolution and 24 accumulation cycles to record IR spectroscopy.

### Example 1

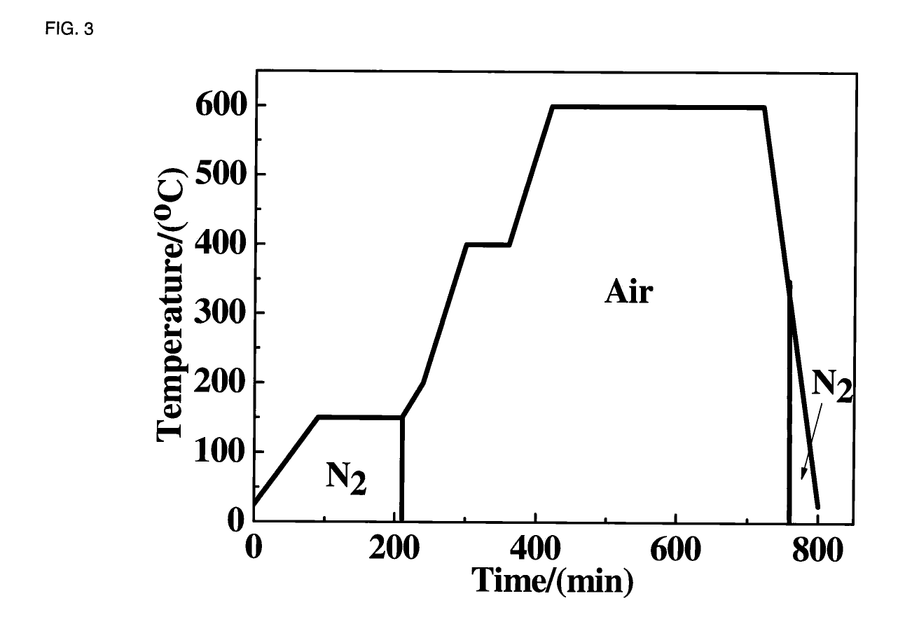

10 g of silica gel (having a pore volume of 1.5 cm³/g and a surface area of 250 m²/g) was impregnated with an aqueous solution containing chromium acetate hydroxide in a concentration of 0.694 g/L, which loaded Cr_{CAH} in an amount of about 0.25% by weight (based on the mass of Cr) relative to the total weight of the hybrid catalyst. After being continuously stirred for 5 h in the solution, the silica gel was heated to 120° C. and dried in air for 12 h. The silica gel loaded with the chromium acetate hydroxide was calcined at a high temperature in a fluidized bed. Finally, the silica gel was naturally cooled down under the protection of nitrogen gas to obtain a conventional Phillips catalyst. The temperature profile of the high-temperature calcining step followed by the cooling step is shown in FIG. 3.

A second impregnation solution containing refined hexane (which has been treated by dehydration and deoxidation) as a solvent and a second chromium precursor bis-triphenylsilylchromate (2.14 g/L) was used to impregnate the Phillips catalyst as described above. The solution and the Phillips catalyst were continuously stirred for 6 h in a bottle at 45° C. under the nitrogen gas atmosphere till the reaction was completed. The amount of Cr_{BC} loaded onto the silica gel by this second impregnation procedure was 0.25% by weight (based on the mass of Cr) relative to the total weight of the hybrid catalyst. Finally, the resultant hybrid catalyst was dried at 80° C. under the nitrogen gas atmosphere for 5 h to remove the solvent and later stored under the protection of nitrogen gas.

The total chromium loading of the hybrid catalyst was 0.5% by weight relative to the total weight of the hybrid catalyst, wherein Cr_{BC} was present in an amount of 50% by weight relative to the total weight of chromium loading.

### Example 2

10 g of silica gel (having a pore volume of 1.5 cm³/g and a surface area of 250 m²/g) was impregnated with an aqueous solution containing chromium acetate hydroxide in a concentration of 1.11 g/L, which loaded Cr_{CAH} in an amount of about 0.4% by weight (based on the mass of Cr) relative to the total weight of the hybrid catalyst. After being continuously stirred for 5 h in the solution, the silica gel was heated to 120° C. and dried in air for 12 h. The silica gel support loaded with the chromium acetate hydroxide was calcined at a high temperature in a fluidized bed. Finally, the silica gel was naturally cooled down under the protection of nitrogen gas to obtain a conventional Phillips catalyst. The temperature profile of the high-temperature calcining step followed by the cooling step is shown in FIG. 3.

A second impregnation solution containing refined hexane (treated by dehydration and deoxidation) as a solvent and a second chromium precursor bis-triphenylsilylchromate (0.86 g/L) was used to impregnate the Phillips catalyst as described above. The solution and the Phillips catalyst were continuously stirred for 6 h in a bottle at 45° C. under the nitrogen gas atmosphere until the reaction was completed. The amount of Cr_{Bc} loaded onto the silica gel by this second impregnation procedure was 0.1% by weight (based on the mass of Cr) relative to the total weight of the hybrid catalyst. Finally, the resultant hybrid catalyst was dried at 80° C. under the nitrogen gas atmosphere for 5 h to remove the solvent and later stored under the protection of nitrogen gas.

The total chromium loading of the hybrid catalyst was 0.5% by weight relative to the total weight of the hybrid catalyst, wherein Cr_{BC} was present in an amount of 20% by weight relative to the total weight of chromium loading.

### Example 3

10 g of silica gel (having a pore volume of 1.5 cm³/g and a surface area of 250 m²/g) was impregnated with an aqueous solution containing chromium acetate hydroxide in a concentration of 0.278 g/L, which loaded Cr_{CAH} in an amount of about 0.1% by weight (based on the mass of Cr) relative to the total weight of the hybrid catalyst. After being continuously stirred for 5 h in the solution, the silica gel was heated to 120° C. and dried in air for 12 h. The silica gel loaded with the chromium acetate hydroxide was calcined at a high-temperature in a fluidized bed. Finally, the silica gel was naturally cooled down under the protection of nitrogen gas to obtain a conventional Phillips catalyst. The temperature profile of the high-temperature calcining step followed by the cooling step above is shown in FIG. 3.

A second impregnation solution containing refined hexane (treated by dehydration and deoxidation) as a solvent and a second chromium precursor bis-triphenylsilylchromate (3.43 g/L) was used to impregnate the Phillips catalyst prepared according to the method described above. The solution and the Phillips catalyst were continuously stirred for 6 h in a bottle at 45° C. under the nitrogen gas atmosphere until the reaction was completed. The amount of Cr_{BC} loaded onto the silica gel by this second impregnation procedure was 0.4% by weight (based on the mass of Cr) relative to the total weight of the hybrid catalyst. Finally, the resultant hybrid catalyst was dried at 80° C. under the nitrogen gas atmosphere for 5 h to remove the solvent and later stored under the protection of nitrogen gas.

The total chromium loading of the hybrid catalyst was 0.5% by weight relative to the total weight of the hybrid catalyst, wherein Cr_{BC} was present in an amount of 80% by weight relative to the total weight of chromium loading.

### Example 4

160 mg of the hybrid catalyst in Example 1 was weighed for the polymerization. The polymerization reaction kettle was first heated (100° C.) under vacuum, and then replaced with highly pure nitrogen, which was repeated for three times. Then a small amount of ethylene monomer was used to replace once. Finally, the reaction kettle was filled with ethylene monomer to a slightly positive pressure (0.12 MPa). The polymerization temperature was maintained at 90° C. About 70 ml of refined heptane (treated by dehydration and deoxidation, and used as a solvent) and triethylaluminum (TEA) (used as co-catalyst) were added respectively to the reaction kettle, wherein the co-catalyst had a concentration of 1.82 mmol/mL in n-hexane solution and was added to the kettle in an amount of 0.08 mL, 0.11 mL, 0.13 mL, 0.17 mL, or 0.25 mL, (i.e., resulting in an Al/Cr (molar ratio) of 10, 12.5, 15, 20, or 30 respectively). Finally the pressure of ethylene monomer in the kettle was raised to 0.14 MPa and the hybrid catalyst was added to the kettle to start the polymerization. During the reaction, the instantaneous consumption rate of ethylene monomer were measured on-line by a high-precision ethylene mass flow meter connected to a computer. The consumption rates were also recorded by the computer. After the reaction was conducted at 90° C. for 1 h, a mixed solution of hydrochloric acid/ethanol was added to the kettle to terminate the reaction, and the polymer was vacuum dried, weighed, and analyzed.

### Example 5

160 mg of the hybrid catalyst in Example 1 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 90° C. About 70 ml of a refined heptane (treated by dehydration and deoxidation and used as a solvent) and triisobutylaluminum (TIBA) (used as co-catalyst) were added respectively to the reaction kettle, wherein the co-catalyst had a concentration of 0.986 mmol/mL in n-hexane solution and was added to the kettle in an amount of 0.23 mL, i.e., resulting in an Al/Cr (molar ratio) of 15. Finally the pressure of ethylene monomer in the kettle was raised to 0.14 MPa and the hybrid catalyst was added to the kettle to start the polymerization. During the reaction, the instantaneous consumption rates of ethylene monomer were measured on-line by a high-precision ethylene mass flow meter connected to a computer and also recorded by the computer. After the reaction was conducted at 90° C. for 1 h, a mixed solution of hydrochloric acid/ethanol was added to terminate the reaction, and the polymer was vacuum dried, weighed, and analyzed.

### Example 6

160 mg of the hybrid catalyst in Example 1 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 90° C. About 70 ml of a refined heptane (treated by dehydration and deoxidation and used as a solvent) and methylaluminoxane (MAO) (used as co-catalyst) were added respectively to the reaction kettle, wherein the co-catalyst had a concentration of 1.5 mmol/mL in n-hexane solution and was added in an amount of 0.92 mL, i.e., resulting in an Al/Cr (molar ratio) of 90. Finally the pressure of ethylene monomer in the kettle was raised to 0.14 MPa and the hybrid catalyst was added to the kettle to start the polymerization. During the reaction, the instantaneous consumption rate of ethylene monomer were measured on-line by a high-precision ethylene mass flow meter connected to a computer and also recorded by the computer. After the reaction was conducted at 90° C. for 1 h, a mixed solution of hydrochloric acid/ethanol was added to terminate the reaction, and the polymer was vacuum dried, weighed, and analyzed.

### Example 7

160 mg of the hybrid catalyst in Example 2 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 90° C. About 70 ml of a refined heptane (treated by dehydration and deoxidation, and used as a solvent) and triethylaluminum (TEA) (as co-catalyst) were added respectively to the reaction kettle, wherein the co-catalyst had a concentration of 1.82 mmol/mL in n-hexane solution and was added in an amount of 0.13 mL, i.e., resulting in an Al/Cr (molar ratio) of 15. Finally the pressure of ethylene monomer in the kettle was raised to 0.14 MPa and the hybrid catalyst was added to the kettle to start the polymerization. During the reaction, the instantaneous consumption rates of ethylene monomer were measured on-line by a high-precision ethylene mass flow meter connected to a computer and also recorded by the computer. After the reaction was conducted at 90° C. for 1 h, a mixed solution of hydrochloric acid/ethanol was added to terminate the reaction, and the polymer was vacuum dried, weighed, and analyzed.

### Example 8

160 mg of the hybrid catalyst in Example 3 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 90° C. About 70 ml of a refined heptane (treated by dehydration and deoxidation, and was used as solvent) and triethylaluminum (TEA) (as co-catalyst) were added respectively to the reaction kettle, wherein the co-catalyst had a concentration of 1.82 mmol/mL in n-hexane solution and was added in an amount of 0.13 mL, i.e., resulting in an Al/Cr (molar ratio) of 15. Finally the pressure of ethylene monomer in the kettle was raised to 0.14 MPa and the hybrid catalyst was added to the kettle to start the polymerization. During the reaction, the instantaneous consumption rates of ethylene monomer were measured on-line by a high-precision ethylene mass flow meter connected to a computer and also recorded by the computer. After the reaction was conducted at 90° C. for 1 h, a mixed solution of hydrochloric acid/ethanol was added to terminate the reaction, and the polymer was vacuum dried, weighed, and analyzed.

### Example 9

160 mg of the hybrid catalyst in Example 1 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 35° C., 50° C., 70° C. and 80° C. respectively. About 70 ml of a refined heptane (treated by dehydration and deoxidation, and used as solvent) and triethylaluminum (TEA) (as co-catalyst) were added respectively to the reaction kettle, wherein the co-catalyst had a concentration of 1.82 mmol/mL in n-hexane solution and was added in an amount of 0.13 mL, i.e., resulting in an Al/Cr (molar ratio) of 15. Finally the pressure of ethylene monomer in the kettle was raised to 0.14 MPa and the hybrid catalyst was added to the kettle to start the polymerization. During the reaction, the instantaneous consumption rates of ethylene monomer were measured on-line by a high-precision ethylene mass flow meter connected to a computer and also recorded by the computer. After the reaction was conducted for 1 h, a mixed solution of hydrochloric acid/ethanol was added to terminate the reaction, and the polymer was vacuum dried, weighed and analyzed.

### Example 10

160 mg of the hybrid catalyst in Example 2 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 50° C. About 70 ml of a refined heptane (treated by dehydration and deoxidation, and used as a solvent) and triethylaluminum (TEA) (as co-catalyst) were added respectively to the reaction kettle, wherein the co-catalyst had a concentration of 1.82 mmol/mL in n-hexane solution and was added in an amount of 0.13 mL, i.e., resulting in an Al/Cr (molar ratio) of 15. Finally the pressure of ethylene monomer in the kettle was raised to 0.14 MPa and the hybrid catalyst was added to the kettle to start the polymerization. During the reaction, the instantaneous consumption rates of ethylene monomer were measured on-line by a high-precision ethylene mass flow meter connected to a computer and also recorded by the computer. After the reaction was conducted at 50° C. for 1 h, a mixed solution of hydrochloric acid/ethanol was added to terminate the reaction, and the polymer was vacuum dried, weighed, and analyzed.

### Example 11

160 mg of the hybrid catalyst in Example 3 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 50° C. About 70 ml of a refined heptane (treated by dehydration and deoxidation, and used as a solvent) and triethylaluminum (TEA) (as co-catalyst) were added respectively to the reaction kettle, wherein the co-catalyst had a concentration of 1.82 mmol/mL in n-hexane solution and was added in an amount of 0.13 mL, i.e., resulting in an Al/Cr (molar ratio) of 15. Finally the pressure of ethylene monomer in the kettle was raised to 0.14 MPa and the hybrid catalyst was added to the kettle to start the polymerization. During the reaction, the instantaneous consumption rates of ethylene monomer were measured on-line by a high-precision ethylene mass flow meter connected to a computer and also recorded by the computer. After the reaction was conducted at 50° C. for 1 h, a mixed solution of hydrochloric acid/ethanol was added to terminate the reaction, and the polymer was vacuum dried, weighed, and analyzed.

### Example 12

160 mg of the hybrid catalyst in Example 1 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 90° C. About 70 ml of a refined heptane (treated by dehydration and deoxidation, and used as a solvent) and triethylaluminum (TEA) (as co-catalyst) were added respectively to the reaction kettle, wherein the co-catalyst had a concentration of 1.82 mmol/mL in n-hexane solution and was added in an amount of 0.13 mL, i.e., resulting in an Al/Cr (molar ratio) of 15. 10 mL of hydrogen gas was fed therein, and finally the pressure of ethylene monomer in the kettle was raised to 0.14 MPa, and the hybrid catalyst was added to kettle to start the polymerization. During the reaction, the instantaneous consumption rates of ethylene monomer were measured on-line by a high-precision ethylene mass flow meter connected to a computer and also recorded by the computer. After the reaction was conducted at 90° C. for 1 h, a mixed solution of hydrochloric acid/ethanol was added to terminate the reaction, and the polymer was vacuum dried, weighed, and analyzed.

### Example 13

160 mg of the hybrid catalyst in Example 2 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 90° C. About 70 ml of a refined heptane (treated by dehydration and deoxidation, and used as solvent) and triethylaluminum (TEA) (as co-catalyst) were added respectively to the reaction kettle, wherein the co-catalyst had a concentration of 1.82 mmol/mL in n-hexane solution and was added in an amount of 0.13 mL, i.e., resulting in an Al/Cr (molar ratio) of 15. 10 mL of hydrogen gas was fed therein, and finally the pressure of ethylene monomer in the kettle was raised to 0.14 MPa, and the hybrid catalyst was added to the kettle to start the polymerization. During the reaction, the instantaneous consumption rates of ethylene monomer were measured on-line by a high-precision ethylene mass flow meter connected to a computer and also recorded by the computer. After the reaction was conducted at 90° C. for 1 h, a mixed solution of hydrochloric acid/ethanol was added to terminate the reaction, and the polymer was vacuum dried, weighed, and analyzed.

### Example 14

160 mg of the hybrid catalyst in Example 3 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 90° C. About 70 ml of a refined heptane (treated by dehydration and deoxidation, and used as solvent) and triethylaluminum (TEA) (as co-catalyst) were added respectively to the reaction kettle, wherein the co-catalyst had a concentration of 1.82 mmol/mL in n-hexane solution and was added in an amount of 0.13 mL, i.e., resulting in an Al/Cr (molar ratio) of 15. 10 mL of hydrogen gas was fed therein, and finally the pressure of ethylene monomer in the kettle was raised to 0.14 MPa, and the hybrid catalyst was added to the kettle to start the polymerization. During the reaction, the instantaneous consumption rates of ethylene monomer were measured on-line by a high-precision ethylene mass flow meter connected to a computer and also recorded by the computer. After the reaction was conducted at 90° C. for 1 h, a mixed solution of hydrochloric acid/ethanol was added to terminate the reaction, and the polymer was vacuum dried, weighed, and analyzed.

### Example 15

160 mg of the hybrid catalyst in Example 1 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 90° C. About 70 ml of a refined heptane (treated by dehydration and deoxidation, and used as solvent), a refined 1-hexene (treated by dehydration and deoxidation), and triethylaluminum (TEA) (as co-catalyst) were added respectively to the reaction kettle, wherein the co-catalyst had a concentration of 1.82 mmol/mL in n-hexane solution and was added in an amount of 0.13 mL, i.e., resulting in an Al/Cr (molar ratio) of 15. Finally the pressure of ethylene monomer in the kettle was raised to 0.14 MPa and the hybrid catalyst was added to start the polymerization. The amount of 1-hexene added was 2.1 mL, 3.5 mL, or 4.9 mL (i.e. the volume ratio of 1-hexene used for polymerization being 3%, 5%, or 7% by volume relative to the total volume of the solvent). During the reaction, the instantaneous consumption rates of ethylene monomer were measured on-line by a high-precision ethylene mass flow meter connected to a computer and also recorded by the computer. After the reaction was conducted at 90° C. for 1 h, a mixed solution of hydrochloric acid/ethanol was added to terminate the reaction, and the polymer was vacuum dried, weighed, and analyzed.

### Example 16

160 mg of the hybrid catalyst in Example 2 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 90° C. About 70 ml of a refined heptane (treated by dehydration and deoxidation, and used as solvent), a refined 1-hexene (treated by dehydration and deoxidation), and triethylaluminum (TEA) (as co-catalyst) were added respectively to the reaction kettle, wherein the co-catalyst had a concentration of 1.82 mmol/mL in n-hexane solution and was added in an amount of 0.13 mL, i.e., resulting in an Al/Cr (molar ratio) of 15. Finally the pressure of ethylene monomer in the kettle was raised to 0.14 MPa and the hybrid catalyst was added to start the polymerization. The amount of 1-hexene added was 2.1 mL, i.e. the volume ratio of 1-hexene used for polymerization being 3% by volume relative to the total volume of the solvent. During the reaction, the instantaneous consumption rates of ethylene monomer were measured on-line by a high-precision ethylene mass flow meter connected to a computer and also recorded by the computer. After the reaction was conducted at 90° C. for 1 h, a mixed solution of hydrochloric acid/ethanol was added to terminate the reaction, and the polymer was vacuum dried, weighed, and analyzed.

### Example 17

160 mg of the hybrid catalyst in Example 3 was weighed for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 90° C. About 70 ml of a refined heptane (treated by dehydration and deoxidation, and used as solvent), a refined 1-hexene (treated by dehydration and deoxidation), and triethylaluminum (TEA) (as co-catalyst) were added respectively to the reaction kettle, wherein the co-catalyst had a concentration of 1.82 mmol/mL in n-hexane solution and was added in an amount of 0.13 mL, i.e. resulting in an Al/Cr (molar ratio) of 15. Finally the pressure of ethylene in the kettle was raised to 0.14 MPa and the hybrid catalyst was added to start the polymerization. The amount of 1-hexene added was 2.1 mL, i.e. the volume ratio of 1-hexene used for polymerization being 3% by volume relative to the total volume of the solvent. During the reaction, the instantaneous consumption rates of ethylene monomer were measured on-line by a high-precision ethylene mass flow meter connected to a computer and also recorded by the computer. After the reaction was conducted at 90° C. for 1 h, a mixed solution of hydrochloric acid/ethanol was added to terminate the reaction, and the polymer was vacuum dried, weighed, and analyzed.

### Example 18

10 g of silica gel (having a pore volume of 1.5 cm³/g and a surface area of 250 m²/g) was impregnated in an aqueous solution containing chromium acetate in a concentration of 0.737 g/L, which loaded Cr_{CA} in an amount of about 0.25% by weight (based on the mass of Cr) relative to the total weight of the hybrid catalyst to the silica gel. After being continuously stirred for 5 h in the solution, the silica gel was heated to 120° C. and dried in the air for 12 h. The silica gel loaded with chromium acetate was calcined at a high temperature in a fluidized bed. Finally, the silica gel was naturally cooled down under the protection of nitrogen gas to obtain a conventional Phillips catalyst. The temperature profile of the high-temperature calcining step followed by the cooling step is shown in FIG. 3.

A second impregnation solution containing refined hexane (treated by dehydration and deoxidation) as a solvent and a second chromium precursor bis-triphenylsilylchromate (2.14 g/L) was used to impregnate the Phillips catalyst prepared according to the method as described above. The solution and the Phillips catalyst were continuously stirred for 6 h in a bottle at 45° C. under the nitrogen atmosphere until the reaction was completed. The amount of Cr_{Bc} loaded onto the silica gel by this second impregnation procedure was 0.25% by weight (based on the mass of Cr) relative to the total weight of the hybrid catalyst. Finally, the resultant hybrid catalyst was dried at 80° C. under the nitrogen gas atmosphere for 5 h to remove the solvent and later stored under the protection of nitrogen gas.

The total chromium loading of the hybrid catalyst was 0.5% by weight relative to the total weight of the hybrid catalyst, wherein Cr_{BC} was present in an amount of 50% by weight relative to the total weight of chromium loading.

### Comparative Example 1

10 g of silica gel (having a pore volume of 1.5 cm³/g and a surface area of 250 m²/g) was impregnated in an aqueous solution containing chromium acetate hydroxide in a concentration of 1.39 g/L, which loaded chromium in an amount of 0.50% by weight (based on the mass of Cr) relative to the total weight of the catalyst. After being continuously stirred for 5 h in the solution, the silica gel was heated to 120° C. and dried in air for 12 h. The silica gel loaded with chromium acetate hydroxide was calcined at a high temperature in a fluidized bed. Finally, the silica gel was naturally cooled down under the protection of nitrogen gas to obtain a Phillips catalyst. The temperature profile of the high-temperature calcining step followed by the cooling step is shown in FIG. 3.

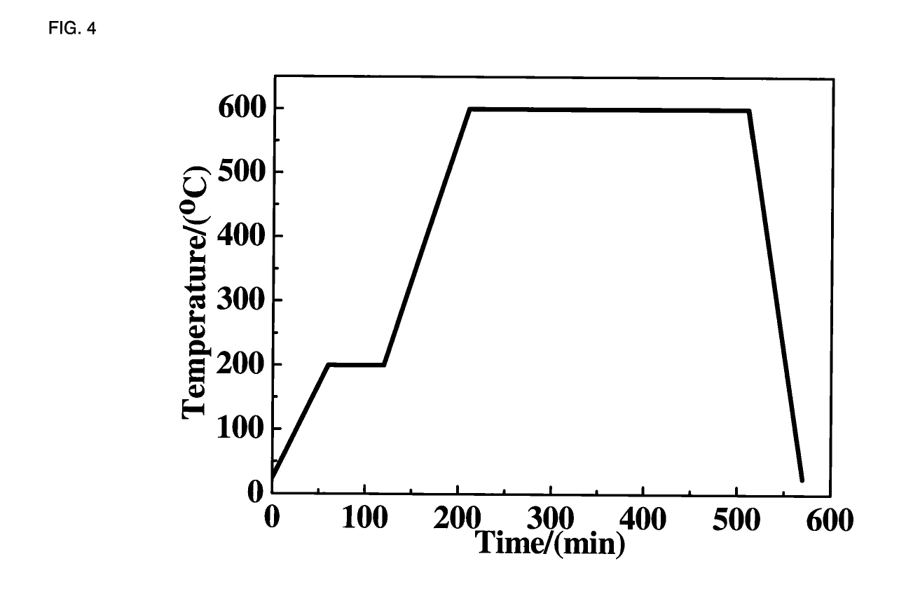

Another impregnation solution containing refined hexane (treated by dehydration and deoxidation) as a solvent and chromium precursor bis-triphenylsilylchromate (4.28 g/L) was used to impregnate another silica gel support (after treated at 600° C., see FIG. 4 for the treating process). The solution and the silica gel were then continuously stirred for 6 h in a bottle at 45° C. and under the nitrogen atmosphere until the reaction was completed. The amount of chromium present in the resultant S-2 catalyst was 0.50% by weight relative to the total weight of the catalyst.

160 mg of each of said two catalysts were used for the polymerization. The polymerization reaction kettle was first heated (100° C.) under vacuum, and then replaced with highly pure nitrogen, which was repeated for three times. A small amount of ethylene monomer was used to replace once. Finally, the reaction kettle was filled with ethylene monomer to a slightly positive pressure (0.12 MPa). The polymerization temperature was maintained at 90° C. About 70 ml of a refined heptane (treated by dehydration and deoxidation, and used as solvent) and triethylaluminum (TEA) (as co-catalyst) were added respectively to the kettle, wherein the co-catalyst had a concentration of 1.82 mmol/mL in n-hexane solution and was added in an amount of 0.13 mL, i.e. resulting in an Al/Cr (molar ratio) of 15. Finally the pressure of ethylene monomer in the kettle was raised to 0.14 MPa and the two catalysts were added. During the reaction, the instantaneous consumption rates of ethylene monomer were measured on-line by a high-precision ethylene mass flow meter connected to a computer and also recorded by the computer. After the reaction was conducted at 90° C. for 1 h, a mixed solution of hydrochloric acid/ethanol was added to terminate the reaction, and the polymer was vacuum dried, weighed, and analyzed.

### IR Spectrogram

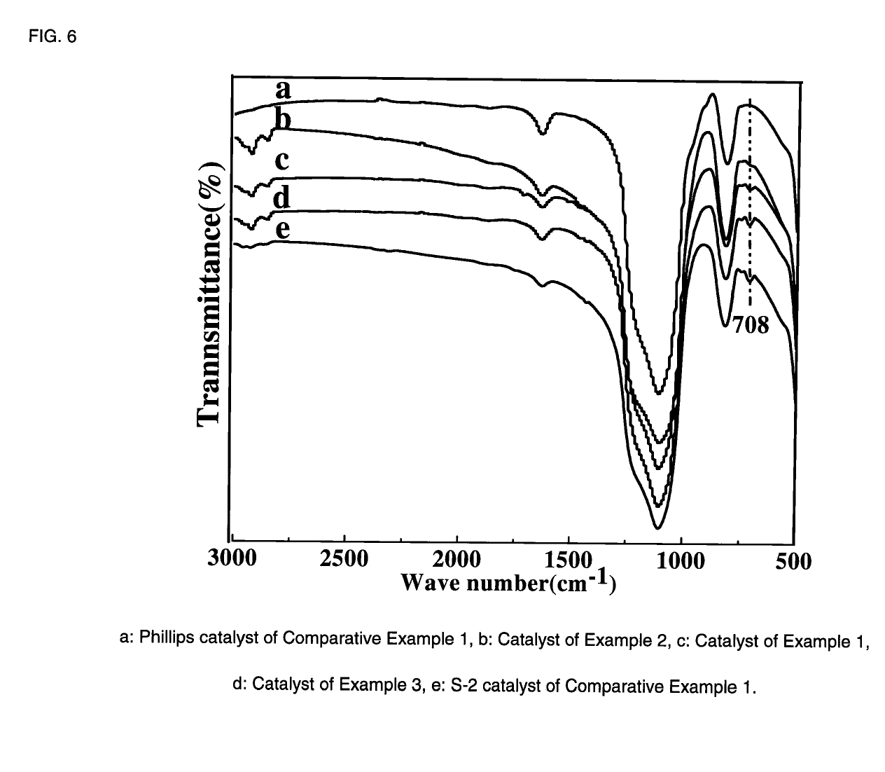

As indicated in FIG. 6, there is a vibration at 708 cm⁻¹(C—H vibration on phenyl ring), indicating organic Cr active sites are present on the supported hybrid chromium-based catalysts of the present disclosure (see for example, H. Suvi, R. Andrew, Journal of Physical Chemistry, 98 (1994), pp. 1695-1703).

### Chromium Content Characterization

About 1 g of catalyst was first washed with 40 ml purified n-hexane for three times under nitrogen atmosphere and then dried at 80° C. Then the catalysts, before and after washing, were weighted in the glove box and then dissolved in HCl solution to prepare samples (sample concentration: about 2.5 mg catalyst/ml). The chromium content of each sample was measured by inductively-coupled plasma (ICP) spectrometer (Vanan 710, from Varian INC). The results of the ICP tests are shown in the table below.

As indicated by the ICP results, inorganic oxide Cr active sites are present on the support because the total Cr loading after washing is higher than the addition amount of organic chromium precursor.

The amount of chromium in different chromium catalysts

| | | | Theoretical | Actual | Relative | Crₜₒₜₐₗ | Relative |
|---|---|---|---|---|---|---|---|
| | | | Crₜₒₜₐₗ | Crₜₒₜₐₗ | Crₜₒₜₐₗ | loading | Crₜₒₜₐₗ |
| | | Relative Cr_{BC} | loading | loading | loading | (wt %) | loss |
| | | Content | (wt %) after | (wt %) after | after | after | after |
| No. | Catalyst | (wt %) | impregnation | impregnation | impregnation | washing | washing |
| 1 | Phillips^{a} | 0 | 0.50 | 0.51 | 100% | 0.51 | 0 |
| 2 | Catalyst of | 20 | 0.50 | 0.42 | 84% | 0.42 | 0 |
| | example 2 | | | | | | |
| 3 | Catalyst of | 50 | 0.50 | 0.44 | 88% | 0.44 | 0 |
| | example 1 | | | | | | |
| 4 | Catalyst of | 80 | 0.50 | 0.45 | 90% | 0.42 | 7% |
| | example 3 | | | | | | |
| 5 | S-2^{b} | 100 | 0.50 | 0.44 | 88% | 0.36 | 18% |

^{a}Phillips catalyst of Comparative Example 1
^{b}S-2 catalyst of Comparative Example 1

### (1) Effect of Co-Catalysts

TABLE 1
Effect of different amount of co-catalyst on the ethylene
homopolymerization

| | Al/Cr | Polymerization activity |
|---|---|---|
| | molar ratio | (kg PE/mol Cr · hr) |
| Compounded catalyst | 10 | 10.6 |
| Compounded catalyst | 12.5 | 39.2 |
| Compounded catalyst | 15 | 32.0 |
| Compounded catalyst | 20 | 30.5 |
| Compounded catalyst | 30 | 17.5 |

Polymerization conditions: ethylene pressure=0.14 MPa; polymerization time=1 hr; polymerization temperature=90° C.; n-heptane=70 mL; catalyst amount=160 mg; total chromium loading=0.5% by weight relative to the total weight of the catalyst; relative amount of Cr_{BC}=50% by weight relative to the total chromium loading; co-catalyst=TEA.

According to Table 1, it can be seen that, under the conditions that TEA is used as co-catalyst (Example 4), the activities of the compounded catalysts in ethylene homopolymerization first increased and then decreased along with the increase amount of the co-catalyst, which shows that there may be an optimal amount of the co-catalyst for achieving a high polymerization activity. There is also a similar trend for other types of co-catalysts.

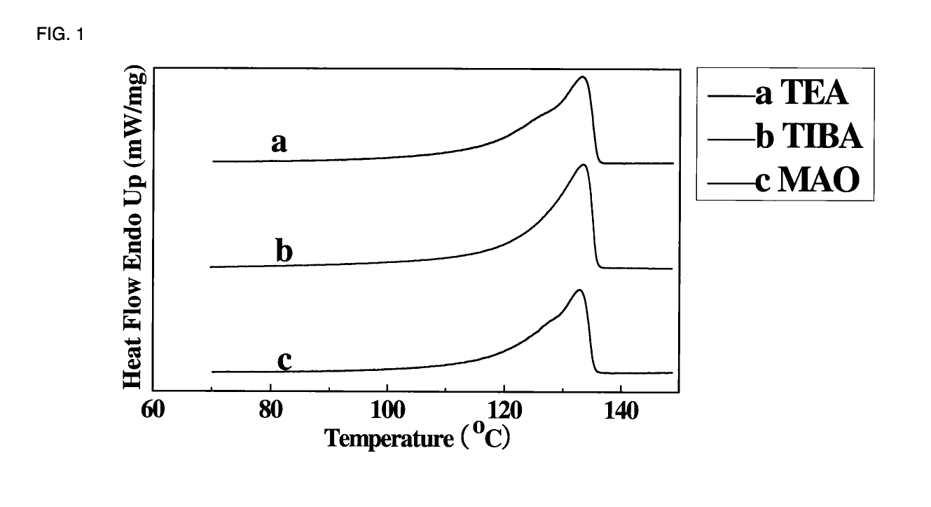

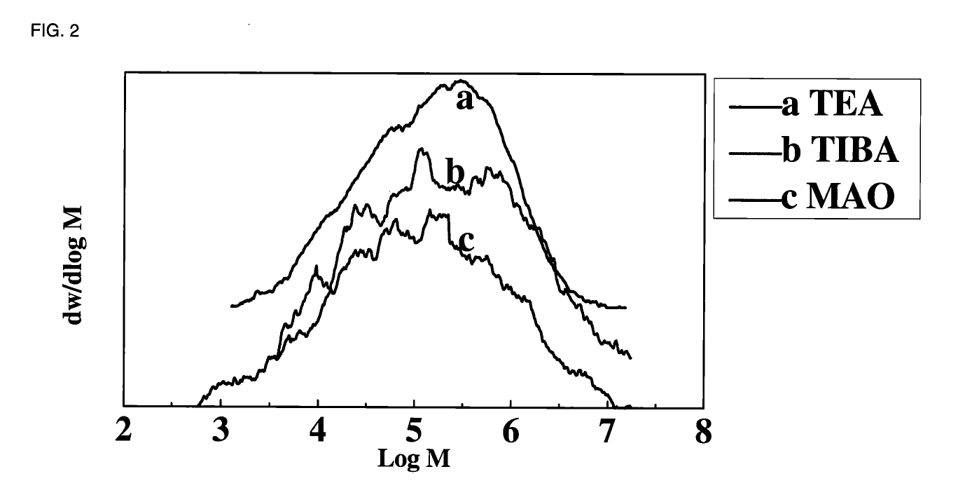

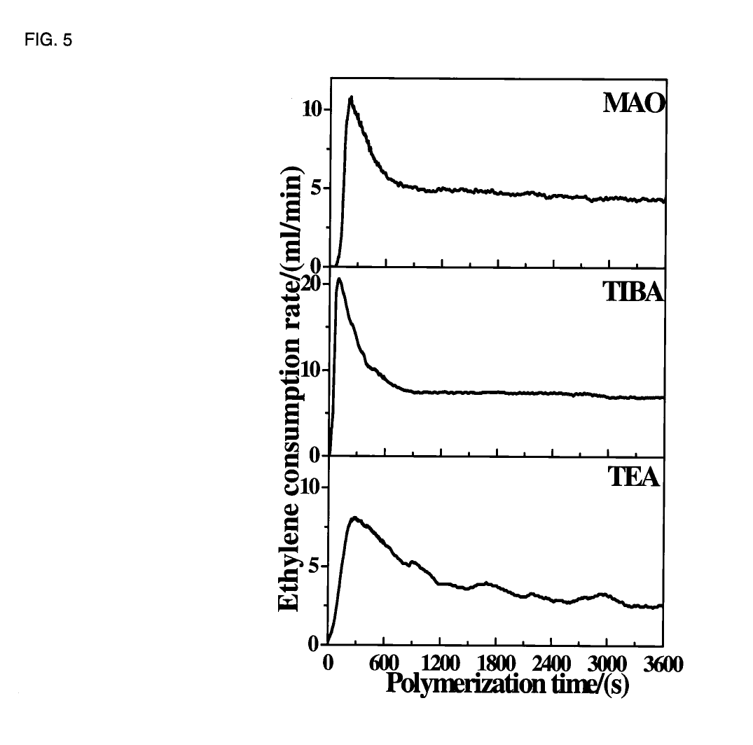

Table 2 shows the results of ethylene polymerization in the presence of different co-catalysts (Examples 4, 5 and 6). According to Table 2, FIG. 1, FIG. 2 and FIG. 5, although the ethylene homopolymerization activities of the hybrid catalysts are different from each other under the action of different co-catalysts, the polymerization kinetics curves are substantially similar, but the time at which the highest ethylene consumption occurred and the peak value of ethylene consumption were different. The kinetics curves show that the ethylene consumption rates increased first then decreased (FIG. 5). Upon further analyses of the polyethylene products above, it can be seen that the polyethylene products prepared with different co-catalysts have similar melting points, but their molecular weight (MW) and molecular weight distribution (MWD) are different. This shows that the choice of co-catalyst may have an effect on the hybrid catalyst's active center's degree of recovery and their distribution after the recovery.

TABLE 2
Effect of different co-catalysts on ethylene homopolymerization

| | | | | Weight | |
|---|---|---|---|---|---|
| | Al/Cr | Polymerization | Melting | average | Molecular |
| | molar | activity (kg | point | molecular | weight |
| Co-catalysts | ratio | PE/mol Cr · hr) | (° C.) | weight (×10⁵) | distribution |
| TEA | 15 | 32.0 | 133 | 4.0 | 9.9 |
| TIBA | 15 | 53.5 | 133 | 7.1 | 14.1 |
| MAO | 90 | 39.9 | 133 | 5.1 | 26.7 |

Polymerization conditions: ethylene pressure=0.14 MPa; polymerization time=1 hr; polymerization temperature=90° C.; n-heptane=70 mL; catalyst amount=160 mg; total chromium loading=0.5% by weight relative to the total weight of the catalyst; relative amount of Cr_{BC}=50% by weight relative to the total chromium loading.

### (2) Effects of the Ratio of Two Chromium Precursors

TABLE 3
Effect of the amount of Cr_{BC} in the hybrid catalysts on ethylene
homopolymerization conducted at 90° C.

| | Polymerization | | Weight average | Molecular |
|---|---|---|---|---|
| Cr_{BC} | activity (kg | Melting | molecular | weight |
| (wt %) | PE/mol. Cr · hr) | point (° C.) | weight (×10⁵) | distribution |
| 20 | 33.1 | 131 | 3.2 | 8.3 |
| 50 | 32.0 | 133 | 4.0 | 9.9 |
| 80 | 32.1 | 132 | 4.4 | 21.3 |

Polymerization conditions: ethylene pressure=0.14 MPa; polymerization time=1 hr; polymerization temperature=90° C.; n-heptane=70 mL; catalyst amount=160 mg; co-catalyst=TEA, Al/Cr (molar ratio)=15; total chromium loading=0.5% by weight relative to the total weight of the catalyst.

Table 3 shows the results of ethylene polymerization using hybrid catalysts prepared with different amount of organic chromium (Examples 4, 7 and 8). The results show that while the catalytic activities of the hybrid catalysts having different amount of Cr_{BC} were relatively similar, and the melting points of the PE products were close, the molecular weight and the molecular weight distribution of the polyethylene products increased with the amount of Cr_{BC} present in the hybrid catalysts.

### (3) Effect of Polymerization Temperature

TABLE 4
Effect of polymerization temperature on ethylene
homopolymerization

| | | Poly- | | Weight | Molec- |
|---|---|---|---|---|---|
| | Poly- | merization | | average | ular |
| Catalysts of | merization | activity | Melting | molecular | weight |
| the present | temperature | (kgPE/ | point | weight | distribu- |
| disclosure | (° C.) | mol Cr · hr) | (° C.) | (×10⁵) | tion |
| Compounded | 35 | 43.6 | 133 | 8.7 | 13.9 |
| catalyst | | | | | |
| Compounded | 50 | 60.9 | 133 | 9.1 | 23.5 |
| catalyst | | | | | |
| Compounded | 70 | 49.9 | 132 | 7.9 | 12.6 |
| catalyst | | | | | |
| Compounded | 80 | 38.9 | 131 | 5.9 | 23.7 |
| catalyst | | | | | |
| Compounded | 90 | 32.0 | 133 | 4.0 | 9.9 |
| catalyst | | | | | |

Polymerization conditions: ethylene pressure=0.14 MPa; polymerization time=1 hr; n-heptane=70 mL; catalyst amount=160 mg; total chromium loading=0.5% by weight relative to the total weight of the catalyst; co-catalyst=TEA, Al/Cr (molar ratio)=15; relative amount of Cr_{BC}=50% by weight relative to the total chromium loading.

Table 4 shows the results of ethylene polymerization conducted at different polymerization temperatures (Examples 4 and 9). The results shows that the polymerization temperature may have an effect on the chain transfer polymerization and chain propagation, and also may have certain effects on the hybrid catalysts' two active centers for producing high and low molecular weight polymers.

Table 5 shows the results of ethylene polymerization using hybrid catalysts prepared with different amount of organic chromium (Examples 4, 10 and 11). By comparing the data in Tables 3 and 5, it can be seen that, when the polymerization temperature was decreased from 90° C. to 50° C., the ethylene homopolymerization activity increased. The degree of increase decreases with the increased amount of Cr_{BC} in the hybrid catalysts. With the decrease of the polymerization temperature, the weight average molecular weights of the homopolymerization products increased. However, the extent of the molecular weight increase of the products decreases along with the increased amount of the Cr_{BC} in the hybrid catalysts.

TABLE 5
Effect of the amount of Cr_{BC} in the hybrid catalysts on ethylene
homopolymerization conducted at 50° C.

| | Polymerization | Melting | Weight average | Molecular |
|---|---|---|---|---|
| Cr_{BC} Content | activity (kg | point | molecular weight | weight |
| (wt %) | PE/mol Cr · hr) | (° C.) | (×10⁵) | distribution |
| 20 | 91.6 | 133 | 9.0 | 8.1 |
| 50 | 60.9 | 133 | 9.1 | 23.5 |
| 80 | 63.8 | 132 | 7.7 | 8.3 |

Polymerization conditions: ethylene pressure=0.14 MPa; polymerization time=1 hr; polymerization temperature=50° C.; n-heptane=70 mL; catalyst amount=160 mg; co-catalyst=TEA, Al/Cr (molar ratio)=15; total chromium loading=0.5% by weight relative to the total weight of the catalyst.

### (4) Effect of Hydrogen Gas on the Polymerization Performance

TABLE 6
Effect of the amount of Cr_{BC} in the hybrid catalysts on the ethylene
homopolymerization conducted in the presence of hydrogen gas

| | Polymerization | Melting | Weight average | Molecular |
|---|---|---|---|---|
| Cr_{BC} Content | activity (kg | point | molecular weight | weight |
| (wt %) | PE/mol Cr · hr) | (° C.) | (×10⁵) | distribution |
| 20 | 31.8 | 126 | 2.0 | 39.6 |
| 50 | 23.1 | 126 | 1.9 | 9.5 |
| 80 | 20.0 | 125 | 2.9 | 33.8 |

Polymerization conditions: ethylene pressure=0.14 MPa; polymerization time=1 hr; polymerization temperature=90° C.; n-heptane=70 mL; catalyst amount=160 mg; total chromium loading=0.5% by weight relative to the total weight of the catalyst; co-catalyst=TEA, Al/Cr (molar ratio)=15; hydrogen gas=10 mL.

Table 6 shows the results of ethylene polymerization using hybrid catalysts prepared with different amount of organic chromium (Examples 12, 13 and 14). Comparing the data shown in Table 5 to Table 3 shows that the presence of hydrogen gas led to lower ethylene homopolymerization activities, melting point, and the weight average molecular weight of the polymer of the hybrid. This shows that hydrogen gas may act as a chain transfer agent to decrease the molecular weight and melting point.

### (5) Effect of the Amount of 1-Hexene on Ethylene/1-Hexene Copolymerization

TABLE 7
Effect of the amount of 1-hexene on ethylene/1-hexene
copolymerization

| | | Poly- | | | Molec- |
|---|---|---|---|---|---|
| | | merization | | Weight | ular |
| Catalysts of | | activity | Melting | average | weight |
| the present | 1-hexene | (kg PE/mol | point | molecular | distribu- |
| disclosure | (Vol %) | Cr · hr) | (° C.) | weight (×10⁵) | tion |
| Compounded | 0 | 32.0 | 133 | 4.0 | 9.9 |
| catalyst | | | | | |
| Compounded | 3 | 23.6 | 125 | 4.0 | 22.3 |
| catalyst | | | | | |
| Compounded | 5 | 18.8 | 122 | 4.2 | 17.4 |
| catalyst | | | | | |
| Compounded | 7 | 21.2 | 122 | 2.8 | 7.1 |
| catalyst | | | | | |

Polymerization conditions: ethylene pressure=0.14 MPa; polymerization time=1 hr; polymerization temperature=90° C.; n-heptane=70 mL; catalyst amount=160 mg; total chromium loading=0.5% by weight relative to the total weight of the catalyst; co-catalyst=TEA, Al/Cr (molar ratio)=15.

Table 7 shows the results of the compounded catalyst in ethylene/1-hexene polymerization (Example 15). The ethylene/1-hexene copolymerization activity of the compounded catalyst decreased with increase amount of 1-hexene; and in comparison with the ethylene homopolymerization results, the ethylene/1-hexene copolymerization activities were lower than those of ethylene homopolymerization. The addition of the 1-hexene makes the melting point of the product polyethylene lower than the homopolymerization product, and the decrease is obvious along with the increase amount of 1-hexene. When the addition amount of the comonomer 1-hexene goes beyond 5 vol. %, the molecular weight and molecular weight distribution of the product polyethylene both are greatly decreased as compared with the homopolymerization product; when the addition amount thereof falls within 0-5 vol. %, the molecular weights of the polyethylene products are substantially unchanged, but the molecular weight distributions thereof are greatly broadened.

TABLE 8
Effect of different Cr_{BC} loading on ethylene/1-hexene
copolymerization

| | Polymerization | | Weight average | Molecular |
|---|---|---|---|---|
| Cr_{BC} | activity (kg | Melting point | molecular | weight |
| (wt %) | PE/mol. Cr · hr) | (° C.) | weight (×10⁵) | distribution |
| 20 | 26.0 | 124 | 4.6 | 33.4 |
| 50 | 23.4 | 125 | 4.1 | 22.3 |
| 80 | 21.8 | 124 | 6.2 | 22.7 |

Polymerization conditions: ethylene pressure=0.14 MPa; polymerization time=1 hr; polymerization temperature=90° C.; n-heptane=70 mL; catalyst amount=160 mg; total chromium loading=0.5% by weight relative to the total weight of the catalyst; co-catalyst=TEA, Al/Cr (molar ratio)=15; 1-hexene amount=3 vol. %.

Table 8 shows (Examples 15, 16 and 17) that the ethylene/1-hexene copolymerization activity and polymer melting point are lower than those of the corresponding homopolymerized products (see e.g. Table 3), and their molecular weights are notably increased. When the content of bis-triphenylsilylchromate on the hybrid catalyst reduced from 50% to 20%, the molecular weight distribution of the polyethylene product increased under the action of comonomer; but when the content of bis-triphenylsilylchromate of the hybrid catalyst increased from 50% to 80%, no significant changes was observed with the molecular weight distribution.

### (6) Comparison Between the Hybrid Catalysts Prepared Using Different Chromium Precursors in Ethylene Homopolymerization

TABLE 9
Comparison in ethylene polymerization

| | | | Polymerization | Melting | | |
|---|---|---|---|---|---|---|
| Catalysts of the | Chromium | Cr_{BC} | activity (kg PE/ | point | Weight average molecular | Molecular weight |
| present disclosure | precursor | (wt %) | mol Cr · hr) | (° C.) | weight (×10⁵) | distribution |
| hybrid | CAH | 50 | 32.0 | 133 | 4.0 | 9.9 |
| catalyst | | | | | | |
| hybrid | CA | 50 | 30.4 | 133 | — | — |
| catalyst | | | | | | |

Polymerization conditions: ethylene pressure=0.14 MPa; polymerization time=1 hr; polymerization temperature=90° C.; n-heptane=70 mL; catalyst amount=160 mg; total chromium loading=0.5% by weight relative to the total weight of the catalyst; co-catalyst=TEA, Al/Cr=15.

According to Table 9 (Examples 4 and 18), the type of chromium precursors used to prepare the hybrid catalyst has no effect on the ethylene polymerization.

What is claimed is:

1. A supported hybrid chromium-based catalyst comprising at least one porous inorganic support, at least one inorganic oxide Cr active site (A), and at least one organic Cr active site (B), wherein the at least one inorganic oxide Cr active site (A) and the at least one organic Cr active site (B) are both supported on one porous inorganic support.

2. The catalyst according to claim 1, wherein the inorganic support is chosen from silica, alumina, titania, zirconia, magnesia, calcium oxide, and inorganic clays, and combinations thereof.

3. The catalyst according to claim 2, wherein the silica is chosen from unmodified, Ti-, Al-, and F-modified amorphous porous silica gels.

4. The catalyst according to claim 2, wherein the inorganic support has a pore volume ranging from 0.5 cm³/g to 5.0 cm³/g.

5. The catalyst according to claim 2, wherein the inorganic support has a surface area ranging from 100 m²/g to 600 m²/g.

6. The catalyst according to claim 1, wherein the at least one inorganic oxide Cr active site (A) is chosen from (a), (b), and (c):

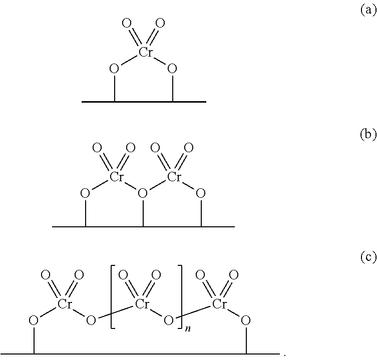

7. The catalyst according to claim 1, wherein the at least one organic Cr active site (B) is in a form of

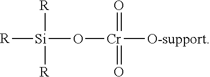

8. The catalyst according to claim 1, wherein the at least one inorganic oxide Cr active site (A) is derived from at least one inorganic chromium precursor chosen from chromium trioxide, chromic nitrate, chromic acetate, chromic chloride, chromic sulfate, ammonium chromate, ammonium dichromate, and chromium acetate hydroxide.

9. The catalyst according to claim 1, wherein the at least one organic Cr active site (B) is derived from at least one organic chromium precursor chosen from compounds of the following formula 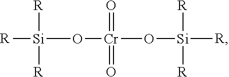
wherein R, which is identical or different from each other, is chosen from hydrocarbyl radicals comprising from 1 to 14 carbon atoms.

10. The catalyst according to claim 9, wherein R is chosen from alkyl radicals and aryl radicals comprising from 1 to 14 carbon atoms.

11. The catalyst according to claim 9, wherein the at least one organic chromium precursor is chosen from bis-trimethylsilylchromate, bis-triethylsilylchromate, bis-tributylsilylchromate, bis-triisopentylsilylchromate, bis-tri-2-ethylhexylsilylchromate, bis-tridecylsilylchromate, bis-tri(tetradecyl)-silylchromate, bis-tribenzylsilylchromate, bis-triphenethylsilylchromate, bis-triphenylsilylchromate, bis-tritolylsilylchromate, bis-trixylylsilylchromate, bis-trinaphthylsilylchromate, bis-triethylphenylsilylchromate, bis-trimethyl-naphthylsilylchromate, polydiphenylsilylchromate, and polydiethylsilylchromate.

12. The catalyst according to claim 1, wherein the total amount of chromium loaded on the at least one inorganic support ranges from 0.01% to 5.00% by weight relative to the total weight of the catalyst.

13. The catalyst according to claim 12, wherein the chromium in the at least one inorganic oxide Cr active site (A) is present in an amount ranging from 10% to 90% by weight relative to the total weight of the chromium loaded on the inorganic support, and the at least one organic Cr active site (B) comprises the remaining amount of the chromium loaded on the inorganic support.

14. A process for preparing a supported hybrid chromium-based catalyst, comprising:
i) impregnating an inorganic support into at least one aqueous solution comprising at least one inorganic chromium precursor, drying, and calcining the inorganic support at a temperature ranging from 500° C. to 900° C.; and
ii) impregnating the inorganic support obtained in step i) into at least one solution comprising at least one organic chromium precursor, and then drying.

15. A process for preparing ethylene homopolymer and/or ethylene/α-olefin copolymer comprising:
contacting at least one ethylene monomer and/or at least one α-olefin with at least one catalyst, wherein the at least one catalyst comprises at least one supported hybrid chromium-based catalyst comprising a porous inorganic support, at least one inorganic oxide Cr active site (A), and at least one organic Cr active site (B), wherein the at least one inorganic oxide Cr active site (A) and the at least one organic Cr active site (B) are both supported on the porous inorganic support.

16. The process according to claim 15, wherein the at least one catalyst is chosen from compounded catalysts comprising the at least one supported hybrid chromium-based catalyst and at least one co-catalyst.
